(19) United States
(12) Patent Application Publication
(10) Pub. No.: US 2005/0151722 A1
(43) Pub. Date: Jul. 14, 2005

(54) Methods and systems for collecting and generating ergonomic data utilizing an electronic portal

(75) Inventor: Jeffrey S. Meteyer, Fairport, NY (US)

Correspondence Address: Ortiz & Lopez, PLLC, P.O. Box 4484, Albuquerque, NM, 87196-4484, US

(73) Assignee: Xerox Corporation

(21) Appl. No.: 10/757,878

(22) Filed: Jan. 14, 2004

(51) Int. Cl. G09G 5/08; G09G 5/00

(52) U.S. Cl. 345/158; 345/156; 345/474

(57) ABSTRACT

Embodiments relate to methods and systems for accessing an electronic portal that collects and provides ergonomic tool data to a user of the electronic portal. Ergonomic data can be compiled that is based on data input by the user to the electronic portal in order to generate ergonomic tool data appropriate to the user. A three-dimensional interactive graphic can be generated for display on a display screen for the user. The user can be prompted to interact with the three-dimensional interactive graphic utilizing a user input device. Ergonomic data can be collected from the user based on input provided by user through the user input device in association with the three-dimensional graphic displayed on the display screen for the user. Additionally, feedback can be provided graphically to the user.

### TECHNICAL FIELD

Embodiments are generally related to electronic information portals. Embodiments are also related to computer networks, including the World Wide Web. Embodiments are also related to methods and systems for collecting and analyzing ergonomic information.

### BACKGROUND OF THE INVENTION

Virtual reality systems are computer based systems that provide the experience of acting in a simulated environment that forms a three dimensional virtual world. These systems are used in several different applications such as commercial flight simulators and entertainment systems including computer games and video arcade games. In virtual reality systems a participant typically wears a head-mounted device that enables viewing of a virtual reality world generated by the computer. The system also includes a data entry and manipulation device, such as a pointing device or a specially configured data glove containing sensors and actuators, for interacting with objects in the virtual world. In somewhat sophisticated systems, a full body suit, also containing sensors and actuators, additionally may be provided so that the user can influence and has a realistic feel of objects in the virtual world.

Data entry and manipulation devices for computers, including virtual reality systems, include keyboards, digitizers, computer mice, joysticks, and light pens. One function of these devices, and particularly computer mice and light pens, is to position a cursor on a display screen of a monitor connected to the computer and cause the computer to perform a set of operations, such as invoking a program, which operations are indicated by the location of the cursor on the screen. Once the cursor is at the desired location, buttons on either the mouse or keyboard are depressed to perform the instruction set. However, over time this may become somewhat tedious, since the user must transfer one of their hands from the keyboard to the mouse, move the mouse cursor to the desired location on the screen, then either actuate a button on the mouse, or transfer their hand back to the keyboard and depress buttons to invoke the program.

Alternative means for data entry and manipulation into computers have been provided in the prior art. One increasingly prevalent data entry device comprises a data entry and data manipulation glove, commonly known as “data gloves” and “virtual reality gloves”. Data gloves are currently used in several virtual reality related applications ranging from virtual reality entertainment and education systems to medical rehabilitation applications. In a virtual reality system, the data glove is provided to enable the operator to touch and feel objects on a virtual screen and to manipulate the objects. Such “data gloves” or “virtual reality gloves” can also be utilized to collect ergonomic information about a user's hand.

In designing tools for use by customers and operators, it is desirable to do so with ergonomic features in mind, particularly those which relate to the needs and specific ergonomic requirements of customers. The market for ergonomically correct tooling for assembly is growing tremendously due to the increasing emphasis on employer liability for repetitive injury cases. Manufacturing resources (e.g., mechanical engineers, model makers, tool makers, and the like), however, can be consumed inefficiently in the design and development of assembly tool solutions. Because the knowledge and availability of such solutions is currently not been communicated properly and efficiently from the manufacturer or supplier to the customer or user, multiple tool creation cycles with small variants are typically experienced. Such conventional manufacturing and distribution processes are inherently inefficient. With the migration of manufacturing plant activity to outsource suppliers, the lack of tool information and communications thereof has increased substantially. Therefore, a solution is needed to overcome the drawbacks of current ergonomic tool assembly problems. Such a solution can be provided through the use of virtual reality systems, and in particular the aforementioned “virtual reality” or data gloves. Such a solution can only be enhanced through the interaction of computer networks, such as the well-known World Wide Web.

### BRIEF SUMMARY

It is, therefore, a feature of the present invention to provide for an improved electronic information portal.

It is another feature of the present invention to provide for electronic information portals which provide collect and analyze ergonomic information based on user input to the electronic portal.

It is also a feature of the present invention to provide for an interactive electronic portal which provides ergonomic tool data that matches ergonomic information provided by a user to the electronic portal.

It is additionally a feature of the present invention to provide for a user input device, such as a virtual reality glove or data glove, which can be utilized to provide user ergonomic information for analysis and compilation thereof.

Aspects of the present invention relate to methods and systems for accessing an electronic portal that collects and provides ergonomic tool data to a user of the electronic portal. Ergonomic data can be compiled that is based on data input by the user to the electronic portal in order to generate ergonomic tool data appropriate to the user. A three-dimensional interactive graphic can be generated for display on a display screen for the user. The user can be prompted to interact with the three-dimensional interactive graphic utilizing a user input device. Ergonomic data can be collected from the user based on input provided by user through the user input device in association with the three-dimensional graphic displayed on the display screen for the user. Additionally, feedback can be provided graphically to the user.

Specific ergonomic data can be generated, in response to compiling ergonomic data based on physical input provided by the user to the electronic portal. Such specific ergonomic data can include a plurality of output variables representative of, for example, weight, twist, grasp, pull, push and motor skills of the user. Such specific ergonomic data can also be analyzed and compared to ergonomic data to data maintained within a database in order to provide particular tool data matching the ergonomic data associated with the user.

A plurality of risk factors can be provided to the user based on an analysis of the ergonomic data compiled in response to user input to the electronic portal. Such plurality of risk factors can comprise at least one of the following risk factors: a high risk factor, wherein ergonomic injury is likely to the user; a medium risk factor, wherein on a short term basis, a substantial risk to the user is unlikely; and a limited risk factor, wherein the user faces a highly unlikely risk of injury. Such risk factors can be graphically displayed on a display screen via a graphical representation of a human body.

### BRIEF DESCRIPTION OF THE DRAWINGS

The accompanying figures, in which like reference numerals refer to identical or functionally-similar elements throughout the separate views and which are incorporated in and form part of the specification further illustrate embodiments of the present invention.

FIG. 1 illustrates a flow-chart of operations illustrative of logical operational steps for carrying out an embodiment of the present invention;

FIG. 2 illustrates a flow-chart of operations illustrative of logical operational steps for carrying out an alternative embodiment of the present invention;

FIG. 3 illustrates a block diagram of alternative systems in which embodiments of the present invention can be implemented; and

FIG. 4 illustrates a pictorial diagram of a user input device which can be adapted for use in accordance with an embodiment of the present invention;

FIG. 5 illustrates a block diagram illustrative of a client/server architecture system in which a preferred embodiment of the present invention can be implemented;

FIG. 6 illustrates a detailed block diagram of a client/server architectural system in which an embodiment of the present invention can be implemented;

FIG. 7 illustrates a high-level network diagram illustrative of a computer network, in which an embodiment of the present invention can be implemented.

### DETAILED DESCRIPTION OF THE INVENTION

The particular values and configurations discussed in these non-limiting examples can be varied and are cited merely to illustrate embodiments of the present invention and are not intended to limit the scope of the invention.

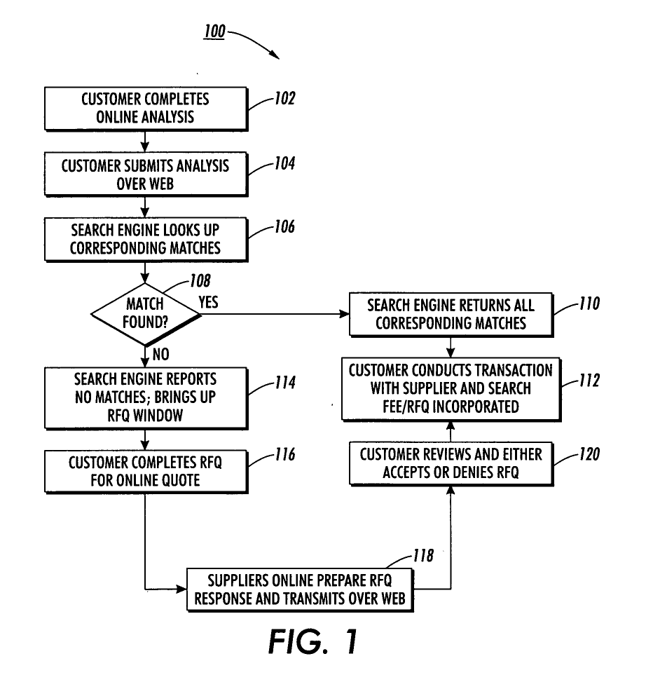

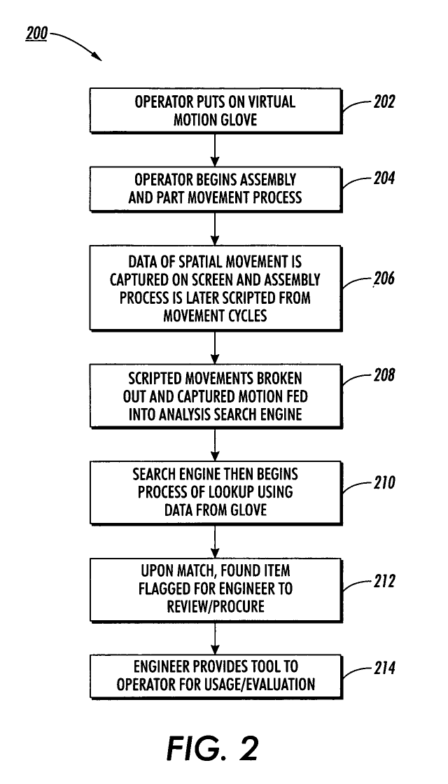

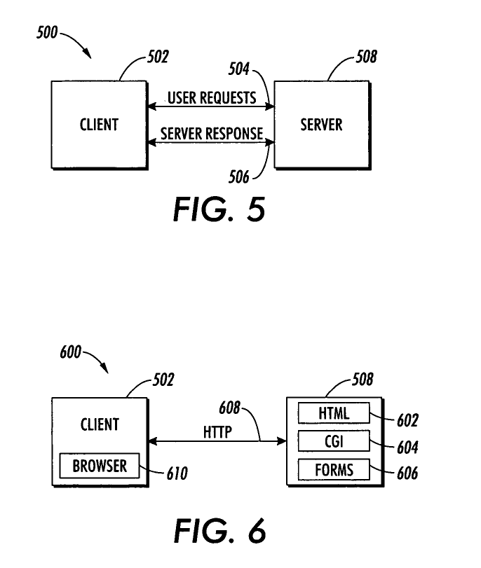

FIG. 1 illustrates a flow-chart 100 of operations illustrative of logical operational steps for carrying out an embodiment of the present invention. In general, respective flow-charts 100 and of FIGS. 1 and 2 are directed toward an electronic portal that allows a user to funnel his or ergonomic and manufacturing tool requirements to an “online” marketplace, wherein an online catalogue of ergonomic tools are presented to the user and transactions thereof implemented. Such an electronic portal can be implemented as a “Web” portal. Note that as utilized herein, the term “Web” generally refers to the well-known “World Wide Web” or WWW, which is a system of Internet servers that utilizes HTTP (Hyper Text Transfer Protocol) to transfer to transfer specially formatted documents compiled formatted via a programming language known as HTML (HyperText Mark-up Language) that supports links to other documents, as well as graphics, audio, and video files. By utilizing the “web”, a user can “jump” from one document to another simply by accessing hyperlinks embedded and displayed within such documents. An example of such a system or network is provided in further detail herein with respect to FIGS. 5-7.

A user can utilize the Web to access an online portal that links users to other individuals or organizations involved in the tool industry. For example, such a portal or Web site can link manufacturing tool providers and their customers. Such a portal can provide a downloadable application that permits manufacturing tool customers to complete an ergonomic analysis of a desired manufacturing tool. The customer or user can submit, via the Web portal, requirements for a particular tool or group of tools and also conduct a search of manufacturers that either have available designs or who desire to bid on development of the tool or group of tools desired by the customer or user. Such a search can be conducted utilizing a search engine that is associated and/or integrated with the Web portal. Note that as utilized herein, the term “search engine” generally refers a type of program, routine and/or subroutine that searches documents for specified keywords and returns a list of the documents or Web pages where the keywords were found.

The term “Web portal” can refer to a Web site or a gateway for a Web site whose purpose is to be a major starting point for users when they connect to the Web for a particular purpose. There are general portals and specialized or niche portals. Typical services offered by public portal sites include a directory of Web sites, a facility to search for other sites, news, weather information, e-mail, stock quotes, phone and map information, and sometimes a community forum. Private portals often include access to payroll information, internal phone directories, company news, and employee documentation.

Thus, as indicated at block 102 of flow-chart 100, a user can access a program via the aforementioned Web portal, which automatically analyzes ergonomic information based on information provided by the user. Such an analysis can be performed by an analysis module. Note that embodiments described herein can be implemented in the context of a “module” or a group of such modules. In the computer programming arts, a module can be typically implemented as a collection of routines and data structures that performs particular tasks or implements a particular abstract data type.

Modules generally are composed of two parts. First, a software module may list the constants, data types, variable, routines and the like that that can be accessed by other modules or routines. Second, a software module can be configured as an implementation, which can be private (i.e., accessible perhaps only to the module), and that contains the source code that actually implements the routines or subroutines upon which the module is based. Thus, for example, the term module, as utilized herein generally refers to software modules or implementations thereof. Such modules can be utilized separately or together to form a program product that can be implemented through signal-bearing media, including transmission media and recordable media. Flow chart 100 of FIG. 1 and flow chart 200 of FIG. 2 can therefore be implemented as a module or group of such modules.

The analysis module, which can be implemented as indicated at block 102, involves an analysis of ergonomic attributes and requirements submitted by the user or customer via the Web portal. The analysis module can operate in association with a compilation module, which compiles compiling ergonomic data based on physical input (i.e., ergonomic input data) provided by the user to the electronic portal through a user input device in order to generate ergonomic tool data to the user based on the physical input, wherein the specific ergonomic data comprises a plurality of output variables representative of weight, twist, grasp, pull, push and motor skills of the user;

Such information can be compared to data stored within a database or repository that houses files of tool solutions (i.e., custom and “off the shelf) that tool suppliers and/or manufacturers can provide to the services offered via the Web portal. Key attributes can include, for example, information such as span of motion, weight, grasp strength, life, twist, pull, push and other such ergonomic data. Following processing of the operation described at block 102, the operation depicted at block 104 can be processed, wherein the user or customer can submit the results of this analysis via the Web portal.

A search engine associated with the Web portal automatically searches for corresponding matches, as indicated at block 106. Such matches are generally based on the analyzed data provided originally by the user or customer. The search engine generally interprets the ergonomic analysis information submitted by the user and analyzed via the aforementioned analysis module. Upon submission of search criteria, the search engine searches for all tools that would potentially match the search parameters generated by the analysis module. The search engine can then return matches in a cascading style sheet page format, allowing the searcher or user to view both static and dynamic representations of the tools at issue, as well as information regarding supplier(s) and/or web links to the web pages associated with such suppliers.

Following processing of the operation illustrated at block 106, a test can be performed, as indicated at block 108, inquiring whether a match has been identified. If a match is identified, based on the results generated by the search engine, then the operation depicted at block 110 is processed. If, however, a match is not found, then the operation described thereafter at block 114 is processed. Assuming that a match is not found, as indicated at block 114, the search engine automatically reports to the user or customer that no matches have been identified.

A “Request for Quote” (RFQ) module can then be implemented, as indicated at block 114, wherein an RFQ “window” is brought up and automatically displayed within a display area of the Web portal for the user to access to obtain an online quote from one or more product manufacturers. Such an RFQ module is therefore activated to allow the outputs from the prior ergonomic evaluation to be incorporated into an RFQ format, as well as attaching any electronic file information to a submitted quote to allow suppliers to review and bid upon the quote. As indicated at block 116, the user or customer completes an RFQ form to request an online quote. Next, as depicted at block 118, suppliers or manufacturers can prepare an RFQ response and transmit such a response (i.e., a quote) back to the user via the Web and the Web portal described earlier.

Thereafter, as illustrated at block 120, the customer receives the quote via the Web portal (or the quote can be automatically transmitted to an e-mail account associated with the user or customer), and can either accept or deny the quote. Following processing of the operation depicted at block 112, the customer can then conduct a financial transaction with the supplier or manufacturer. The transaction can be automatically implemented via the Web portal and a fee deducted as part of the transaction as payment for services rendered by the web portal owner or operator. Such a fee can be, for example, an RFQ fee and/or search fee (i.e., for accessing the web portal's search engine).

The RFQ module can be configured to generate and set particular flags that allow varying security levels for viewing. The RFQ module can also be configured so that only preferred suppliers or pre-approved suppliers have visibility access to such data. The intent, however, of the Web portal is to permit as many solutions to be returned to a customer or user in need of obtaining particular ergonomic tool solutions. Assuming a match is found, as depicted at block 108, the search engine returns all corresponding matches, as depicted at block 108. The operation illustrated at block 110 can then be processed following processing of the operation depicted at block 108.

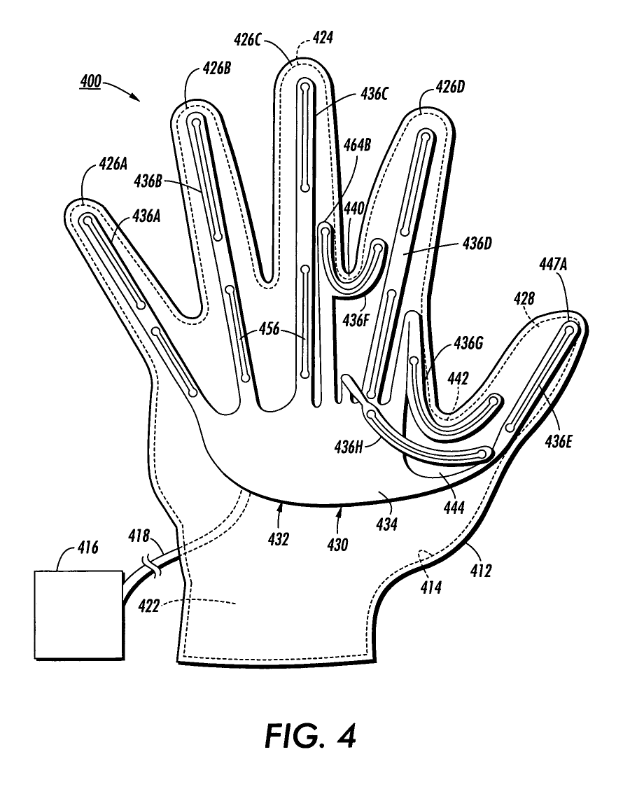

FIG. 2 illustrates a flow-chart 200 of operations illustrative of logical operational steps for carrying out an alternative embodiment of the present invention. Flow-chart 200 generally describes a method in which ergonomic information about a particular user can be input by a user to a data processing system, such as a computer. An example of such a computer is computer 416 depicted and described herein with respect to FIG. 4. Ergonomic data can then be generated and analyzed to assist in obtaining tools that are ergonomically correct for the user. The user can input this data to a Web portal, such as the Web portal or Web site described earlier with respect to FIG. 1. As indicated at block 202, an operator a user can initially place his or her hand into a “virtual” motion glove or other similar user input device. Such a virtual motion glove or other data user input device is associated with the Web portal or Web site.

Thus, motion and other ergonomic data associated with the user can be captured by an interface associated with the “virtual” motion glove (i.e., a virtual reality data input device). Ergonomic data captured by the data input device can be, for example, information such as grip intensity, repetitive motion, twist, flex, turn, life, push, pull and the like. Such information can be input to an analysis engine or analysis module which analyzes the ergonomic information collected from the user via the user input device, such as the virtual motion or data glove described herein (e.g., see FIG. 4).

The analysis module can then utilize this information in association with a generating module to generate a profile of motion that is helpful in summarizing the amount of user activity encountered and, after cross-referencing this information with a known user physical profile (e.g., user-specific factors such as age, height weight, known medical history, problem areas of concern), potential user ergonomic risk areas can highlighted in a color pattern, such as, for example, a red/yellow/green code sequence or a variation thereof. Such a generating module can form a module separate from the analysis module or can be implemented as a subroutine incorporated into the analysis module, depending upon desired embodiments. The generating module can generate a plurality of risk factors for the user based on an analysis of ergonomic data compiled based on the physical input provided by the user to the for the user based on the physical user input.

A red area displayed on a display screen can indicate to a user that areas associated with the color red are considered “high risk”. That is such red areas indicate portions of a human body (e.g., a human wrist) where ergonomic injury is very likely to occur. A yellow area displayed via a display screen would be deemed a “medium risk” to the user. Yellow areas indicate that on a short term basis, a substantial risk to the individual user's current situation would not be likely. Finally, a green area displayed on a display screen can indicate that there is little to no risk of injury in the long term to the user for those areas associated with the color green. All such information can be represented in output form via a display screen or other output device (e.g., a color printer) as a physical representation of the human body.

An ergonomic analysis can then be available to a requestor to support a business cases for tool purchase and/or construction. Upon analysis review, the search engine described earlier can then cycle through a search pattern based on the individual user's assessment and profiles, and identify current tooling available, as well as tools externally available through other tool supply houses. If a match exists (e.g., see block 108 of FIG. 1), or if a tool indicated as being used for a similar part number use is available, the tool's specification sheet, usage and/or availability can printed for a user and/or simply displayed for a user on a display screen. Such information can also be displayed for a user via the Web portal or Web site utilizing electronic movie formats (e.g., AVI, QuickTime, MPEG, and the like) and/or digital imaging (e.g., JPEG, etc).

Thus, following processing of the operation depicted at block 202, the operation illustrated at block 204 can be processed in which the operator or use begins assembly and initiation of the part movement process. Thereafter, as illustrated at block 206, spatial movement data can be captured on screen and an assembly process scripted based on movement cycles associated with the user, which were captured earlier utilizing the virtual reality “glove” interface or other user input device. Next, as depicted at block 208, scripted movements or “acts” can be broken out and the captured motion fed in an analysis module and a search engine thereof, such as the search engine described earlier herein.

Thereafter, as depicted at block 210, the search engine can begin the process of searching using data collected from the virtual reality “glove” interface or a similar user input device for collecting user ergonomic data. Data utilized by the search engine as part of the search process can include for example, lift, pinch, pull, grasp, push, twist, and the like. Next, as indicated at block 212, upon a match, items found can be flagged for an engineer to review and/or procure proper ergonomically correct tools for the user. The engineer can then, as depicted at block 214, provide the actual tool to the operator or user for usage and evaluation thereof.

The advantage of the embodiments of FIGS. 1 and 2 is that proper tooling issues and ergonomic situations can be addressed prior to product launch, and therefore repetitive injury and/or stress to a user can be substantially reduced. Additionally, the visibility of the particular types of tooling available for particular situations can aid a manufacturing engineer or ergonomist by providing such individuals with the types of tools that are presently available and prevent the practice of “re-inventing the wheel” so to speak each time an ergonomically correct tool is required.

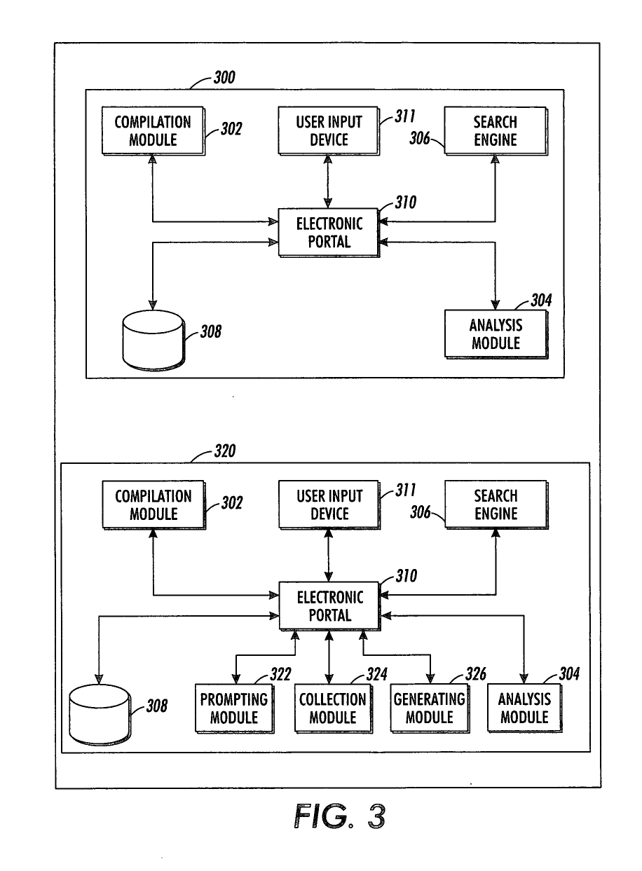

FIG. 3 illustrates a block diagram of alternative systems 300 and 220 in which embodiments of the present invention can be implemented. FIG. 3 depicts alternative embodiments of the present invention. System 300 generally includes an electronic portal 310 that can collect and provides ergonomic tool data to a user of electronic portal 310. Electronic portal 310 can also access a database 308, which contains ergonomic tool information, including a database of ergonomic tools and manufacturers and suppliers of such ergonomic devices.

System 300 can also be configured to include a compilation module for compiling ergonomic data based on physical input provided by the user to the electronic portal in order to generate ergonomic tool data to the user based on the physical input. Such physical user input can be provided via a user input device 311. A search engine 306 is also associated with electronic portal 310. Additionally, system 300 includes an analysis module for analyzing and comparing specific ergonomic data collected from user input device 311 to data maintained within database 308 to thereby provide particular tool data that matches specific ergonomic data associated with a particular user (e.g., operator, engineer, ergonomist, customer, etc.).

System 320 is similar to system 300. Note that in system 300 and system 320 identical or analogous parts or elements are indicated by identical reference numerals. System 320 thus additionally includes a prompting module 322, a collection module 324 and a generating module 326, which are also associated with and/or integrated with electronic portal 310 of system 320. Prompting module 322 can be utilized to prompt a user to interact with a three-dimensional interactive graphic utilizing the user input device (e.g., a virtual reality “glove”). Collection module 324 can collect ergonomic data from the user based on input provided by user through the user input device in association with the three-dimensional graphic displayed on a display screen for the user. Generating module 326 can then generate specific ergonomic data is generated in response to compiling ergonomic data based on physical input provided by the user to the electronic portal in order to generate ergonomic tool data for the user based on the physical input.

FIG. 4 illustrates a pictorial diagram of a user input device 400 which can be adapted for use in accordance with an embodiment of the present invention. User input device 400 is described herein for illustrative purposes only and is not considered a specific limiting feature of the present invention. Other types of user input device or variations thereof can also be implemented in accordance with preferred or alternative embodiments. User input device 400 can therefore be implemented as a data input glove having a glove portion 412 configured to be worn on a wearer's hand 414. A computer 416 for processing data control signals generated by the data glove 410 can be implemented in association with a data cable 418 coupling the data glove 410 to the computer 416 for data transfer therebetween.

Data generated from the processed control signals can be transmitted to the computer 416 for processing in real time. The data can be continuously processed so that an object in a virtual reality program, or other appropriate program or module or application (e.g., see FIGS. 1-2), which is running on the computer 410 can be manipulated in real time while the program and/or modules thereof are running. Computer 416 can be implemented, for example, as a client or server or a combination thereof operating in a computer network. For example, computer 410 can be implemented as client 502 and/or server 508 of FIGS. 5-7 herein.

The glove portion 412 of the data glove (i.e., user input device 400) can be constructed from an elastic material closely matching the shape of the wearer's hand 414, while enabling the wearer to move their hand 414 freely. Additionally, the elastic material can be preferably breathable which is comfortable for the wearer. The glove portion 412 can be configured with an aperture 420 that extends over a dorsal region 422 of the wearer's hand 414 and along a dorsal region 424 of each of their fingers 426 and thumb 428. Suitable textiles for fabricating the glove portion 412 include spandex and super-spandex.

A movement sensing unit 430 can be provided for sensing any movements of the wearer's hand 414, such as any movement of the fingers 426, thumb 428, or hand 414 itself. The sensing unit 430 is preferably retained in the aperture 420 of the glove 412, for sensing any hand gestures of the wearer. Securing the sensing unit 430 within the aperture 420 prevents the unit 430 from contacting the hand 414 and from being positioned externally on the data glove 410 which can substantially limit the wearer's freedom of movement and may expose the unit 430 to damage.

The sensing unit 430 can comprise a flexible circuit board 432 that is generally configured to extend along the dorsal region 424 of the wearer's fingers 426, thumb 428 and hand 414. The circuit board 432 can include a base region 434 and a plurality of movement sensor electrodes 436. The base region 434 can be provided with a signal processing means for processing received signals generated by the sensors 436. The processing means may comprise commercially available integrated circuit semiconductor devices such as multiplexers and de-multiplexers for processing the signals generated by the sensors 436, and generating data indicative of the movements of the sensors 436; i.e., the hand gestures of the wearer. Once the signals are processed, the data can be transmitted to the computer 416 via the data cable 418 for manipulating the program running on the computer 416.

The movement sensors 436 include a plurality of elongated portions of the flexible circuit board 432 that extend outwardly from the base region 434. In the preferred embodiment of the present invention 410, a sensor 436 is provided for sensing movement in each of the wearer's fingers 426 and thumb 428, with additional sensors provided for sensing additional regions of the wearers hand 414. Preferably, a first sensor 436A can be provided to sense movements of the little finger 426A, a second sensor 436B senses the ring finger 426B, a third sensor 436C senses the middle finger 426C, a fourth sensor 36D senses movement of the index finger 426D, and a fifth sensor 436E is provided to sense the thumb 428. Each side of the thumb sensor 36E also be provided with a layer of resistive material 456 that extends from the distal end 447A of the sensor 436E toward a mid-region thereof. The extension and flexion sensor 436F can be provided with a layer of resistive material 456 that extends from a distal end thereof to a mid-region 464B of the sensor 436F, while the thumb roll sensor 436H is generally provided with a layer of material 456 that extends substantially the length thereof.

Additionally, an adduction and abduction sensor 436F may be provided for sensing movement in a web area 440 between the index finger 426D and middle finger 426C, and a thumb extension sensor 436G provided for sensing a web area 42 between the wearer's index finger 426D and thumb 428. If desired, a further sensor 436H, referred to as a thumb roll sensor, may be provided for sensing movement of a dorsal region 444 of the hand 14 that extends generally between the base of the index finger 426D to the base of the thumb 428.

Each of the fingers 426, thumb 428, and hand regions 440, 442, 444 can be simultaneously monitored for determining any movement of the wearers hand 414 for collection of ergonomic data thereof related to the user's hand. Any movement of the fingers 426, thumb 428, or hand 414, can cause some degree of flexure of one or more of the sensors 436, causing the appropriate sensors 436 to transmit signals to the processing means 438 for transmitting representative data to the computer 416. Thus, any movement of the hand 414, indicating hand gestures thereby, can be transmitted to the computer 416 in real time and ergonomic information thereof collected and processed via computer 416. Additionally, a layer of a suitable variable resistive material 456 can be disposed over a portion of each outer insulating lamina of the sensors 436 for additional ergonomic data collection thereof. User input device 400 therefore comprises user a input device that includes one or more motion detectors configured with a plurality of pressure and weight sensors thereof for collecting ergonomic data regarding a user's hand.

FIG. 5 illustrates a block diagram illustrative of a client/server architecture system 500 in which a preferred embodiment of the present invention can be implemented. As indicated in FIG. 5, user requests 504 for data can be transmitted by a client 502 (or other sources) to a server 508. Server 508 can be implemented as a remote computer system accessible over the Internet, the meaning of which is known, or other communication networks. Note that the term “Internet” is well known in the art and is described in greater detail herein. Also note that the client/server architecture described in FIGS. 5, 6 and 7 represents merely an exemplary embodiment. It is believed that the present invention can also be embodied in the context of other types of network architectures, such as, for example company “Intranet” networks, token-ring networks, wireless communication networks, and the like.

Server 508 can perform a variety of processing and information storage operations. Based upon one or more user requests, server 508 can present the electronic information as server responses 506 to the client process. The client process may be active in a first computer system, and the server process may be active in a second computer system, communicating with one another over a communications medium, thus providing distributed functionality and allowing multiple clients to take advantage of information processing and storage capabilities of the server, including information retrieval activities such as retrieving documents from a managed service environment.

FIG. 6 illustrates a detailed block diagram of a client/server architectural system 600 in which an embodiment can be implemented. Although the client and server are processes that are generally operative within two computer systems, such processes can be generated from a high-level programming language, which can be interpreted and executed in a computer system at runtime (e.g., a workstation), and can be implemented in a variety of hardware devices, either programmed or dedicated.

Client 502 and server 508 communicate utilizing the functionality provided by HTTP. Active within client 502 can be a first process, browser 610, which establishes connections with server 508, and presents information to the user. Any number of commercially or publicly available browsers can be utilized in various implementations in accordance with the preferred embodiment of the present invention. For example, a browser can provide the functionality specified under HTTP. A customer administrator or other privileged individual or organization can configure authentication policies, as indicated herein, using such a browser.

Server 608 can execute corresponding server software, such as a gateway, which presents information to the client in the form of HTTP responses 608. A gateway is a device or application employed to connect dissimilar networks (i.e., networks utilizing different communications protocols) so that electronic information can be passed or directed from one network to the other. Gateways transfer electronic information, converting such information to a form compatible with the protocols used by the second network for transport and delivery. Embodiments can employ Common Gateway Interface (CGI) 604 for such a purpose.

The HTTP responses 608 generally correspond with “Web” pages represented using HTML, or other data generated by server 508. Server 508 can provide HTML 602. The Common Gateway Interface (CGI) 604 can be provided to allow the client program to direct server 508 to commence execution of a specified program contained within server 508. Through this interface, and HTTP responses 608, server 508 can notify the client of the results of the execution upon completion.

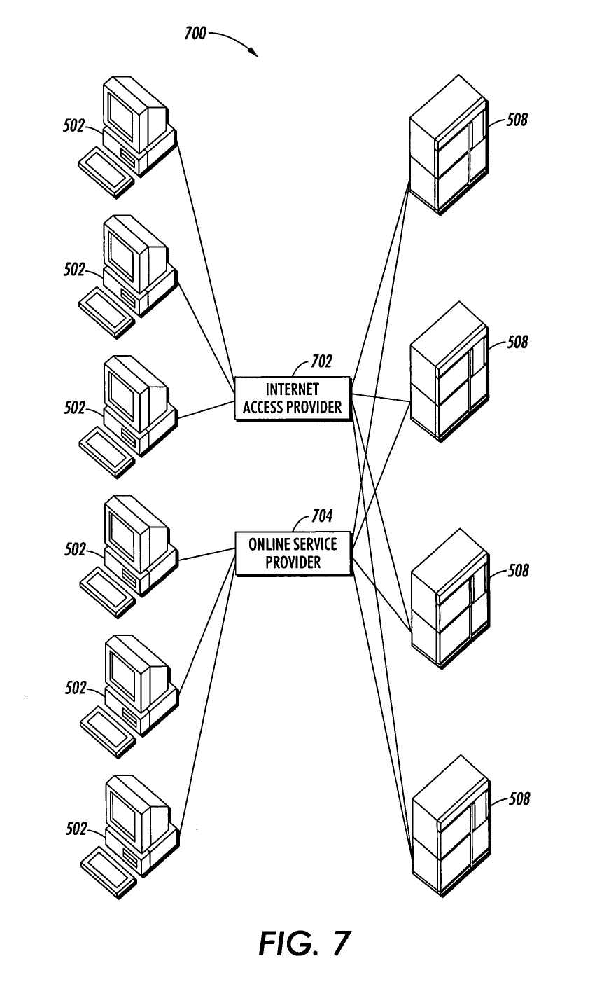

FIG. 7 illustrates a high-level network diagram illustrative of a computer network 700, in which embodiments can be implemented. Computer network 700 can be representative of the Internet, which can be described as a known computer network based on the client-server model discussed herein. Conceptually, the Internet includes a large network of servers 508 that are accessible by clients 502, typically users of personal computers, through some private Internet access provider 702 or an on-line service provider 304.

Each of the clients 502 can operate a browser to access one or more servers 108 via the access providers. Each server 508 operates a so-called “Web site” that supports files in the form of documents and web pages. A network path to servers 508 is generally identified by a Universal Resource Locator (URL) having a known syntax for defining a network collection. Computer network 700 can thus be considered a Web-based computer network.

It can be appreciated that various other alternatives, modifications, variations, improvements, equivalents, or substantial equivalents of the teachings herein that, for example, are or may be presently unforeseen, unappreciated, or subsequently arrived at by applicants or others are also intended to be encompassed by the claims and amendments thereto.

1. A method, comprising:
accessing an electronic portal that collects and provides ergonomic tool data to a user of said portal; and
compiling ergonomic data based on physical input provided by said user to said electronic portal in order to generate ergonomic tool data to said user based on said physical input.

2. The method of claim 1 further comprising:
generating a three-dimensional interactive graphic for display on a display screen for said user;
prompting said user to interact with said three-dimensional interactive graphic utilizing a user input device; and
collecting ergonomic data from said user based on input provided by user through said user input device in association with said three-dimensional graphic displayed on said display screen for said user.

3. The method of claim 2 wherein said user input device comprises a motion detector configured with a plurality of pressure and weight sensor.

4. The method of claim 1 further comprising generating specific ergonomic data in response to compiling ergonomic data based on physical input provided by said user to said electronic portal in order to generate ergonomic tool data to said user based on said physical input.

5. The method of claim 4 wherein said specific ergonomic data comprises a plurality of output variables representative of weight, twist, grasp, pull, push and motor skills of said user.

6. The method of claim 4 further comprising analyzing and comparing said specific ergonomic data to data maintained within a database to thereby provide particular tool data matching said specific ergonomic data associated with said user.

7. The method of claim 1 further comprising generating a plurality of risk factors for said user based on an analysis ergonomic data compiled based on physical input provided by said user to said electronic portal in order to generate ergonomic tool data to said user based on said physical input.

8. The method of claim 7 wherein said plurality of risk factors comprise at least one of the following risk factors:
a high risk factor, wherein ergonomic injury is likely to said user;
a medium risk factor, wherein on a short term basis, a substantial risk to said user is unlikely to occur;
a limited risk factor, wherein said user faces a highly unlikely risk of injury; and
wherein said plurality of risk facts are graphically represented for said user on a display screen as a graphical representation of a human body.

9. The method of claim 1 further comprising associating a search engine with said electronic portal, wherein said search engine is accessible by said user through said electronic portal to automatically identify tool data that are potentially ergonomically appropriate for said user, based on said ergonomic data compiled based on physical input provided by said user.

10. A system, comprising:
an electronic portal that collects and provides ergonomic tool data to a user of said portal; and
a compilation module for compiling ergonomic data based on physical input provided by said user to said electronic portal in order to generate ergonomic tool data to said user based on said physical input.

11. The system of claim 10 further comprising:
a prompting module for prompting said user to interact with said three-dimensional interactive graphic displayed on a display for said user utilizing user input device; and
a collection module for collecting ergonomic data from said user based on input provided by user through said user input device in association with said three-dimensional graphic displayed on said display screen for said user.

12. The system of claim 11 wherein said user input device comprises a motion detector configured with a plurality of pressure and weight sensor.

13. The system of claim 10 wherein specific ergonomic data is generated in response to compiling ergonomic data based on physical input provided by said user to said electronic portal in order to generate ergonomic tool data to said user based on said physical input.

14. The system of claim 13 wherein said specific ergonomic data comprises a plurality of output variables representative of weight, twist, grasp, pull, push and motor skills of said user.

15. The system of claim 13 further comprising an analysis module for analyzing and comparing said specific ergonomic data to data maintained within a database to thereby provide particular tool data matching said specific ergonomic data associated with said user.

16. The system of claim 10 further comprising a generating module for generating a plurality of risk factors for said user based on an analysis ergonomic data compiled based on physical input provided by said user to said electronic portal in order to generate ergonomic tool data to said user based on said physical input.

17. The system of claim 16 further comprising a data input glove for providing said physical input, wherein said data input glove includes a glove portion, which can be worn on a hand of a user and wherein said data input glove generates data control signals processible by a computer which communicates with said data input glove via a data cable.

18. The system of claim 16 wherein said plurality of risk factors comprise at least one of the following risk factors:
a high risk factor, wherein ergonomic injury is likely to said user;
a medium risk factor, wherein on a short term basis, a substantial risk to said user is unlikely;
a limited risk factor, wherein said user faces a highly unlikely risk of injury; and
wherein said plurality of risk factors is graphically represented on a display screen for said user upon a graphical representation of a human body.

19. The system of claim 10 further comprising a search engine associated with said electronic portal, wherein said search engine is accessible by said user through said electronic portal to automatically identify tool data that are potentially ergonomically appropriate for said user, based on said ergonomic data compiled based on physical input provided by said user.

20. A system, comprising:
an electronic portal that collects and provides ergonomic tool data to a user of said portal, wherein said electronic portal can be displayed graphically on a display screen for said user;
a user input device, wherein said user is prompted via said display screen to interact with said three-dimensional interactive graphic utilizing said user input device;
a compilation module for compiling ergonomic data based on physical input provided by said user to said electronic portal through a user input device in order to generate ergonomic tool data to said user based on said physical input, wherein said specific ergonomic data comprises a plurality of output variables representative of weight, twist, grasp, pull, push and motor skills of said user;
an analysis module for analyzing and comparing said specific ergonomic data to data maintained within a database to thereby provide particular tool data matching said specific ergonomic data associated with said user; and
a generating module for automatically generating a plurality of risk factors for said user based on an analysis ergonomic data compiled in response to physical input provided by said user to said electronic portal via said user input device in order to generate ergonomic tool data to said user based on said physical input.
